(19) United States
(12) Patent Application Publication
(10) Pub. No.: US 2006/0210121 A1
(43) Pub. Date: Sep. 21, 2006

(54) Eye opening degree estimating apparatus

(75) Inventors: Yuusuke Nakano, Nagoya-shi (JP); Yuichi Kawakami, Nishinomiya-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/375,146

(22) Filed: Mar. 14, 2006

(30) Foreign Application Priority Data
Mar. 18, 2005 (JP) JP2005-079525

(51) Int. Cl. G06K 9/00; G06K 9/46

(52) U.S. Cl. 382/117; 382/170; 382/190

(57) ABSTRACT

The present invention is directed to provide an eye opening degree estimating apparatus capable of properly estimating the opening degree of an eye. In an eye opening degree estimating apparatus, a search axis used for estimating the eye opening degree is set in an eye region image. By integrating luminance values of the eye region image in positions in the direction of the search axis along the direction perpendicular to the search axis, a vertical-direction integral projection histogram is generated. On the basis of a feature amount of at least one of the vertical-direction integral projection histogram in a position in the direction of the search axis in which the vertical-direction integral projection histogram has an extreme value and the eye region image, the opening degree of an eye included in the eye region image is estimated.

This application is based on application No. 2005-079525 filed in Japan, the contents of which are hereby incorporated by reference.

### BACKGROUND OF THE INVENTION

1. Field of the Invention

The present invention relates to an eye opening degree estimating apparatus for estimating the eye opening degree.

2. Description of the Background Art

Hitherto, an image of a face whose eyes are open the widest is selected manually from a plurality of face images obtained by photographing the face of a human. For example, as a face image which is put on a driver's license, an image of a face whose eyes are open the widest is manually selected from a plurality of face images. However, such a manual selecting work is complicated. It is consequently desired to automatically select an image of a face whose eyes are open the widest from a plurality of face images by automatically estimating the eye opening degree.

As a technique of automatically estimating the eye opening degree, for example, the technique of Japanese Patent Application Laid-Open No. 06-32154 (1994) is known. In this technique, the eye opening degree is estimated from the number of continuous black pixels in the vertical direction of an eye region image.

The technique, however, is easily influenced by tilting of face and glasses and has a drawback that the eye opening degree cannot be properly estimated.

### SUMMARY OF THE INVENTION

The present invention relates to an eye opening degree estimating apparatus for estimating the opening degree of an eye of a human.

According to the present invention, the eye opening degree estimating apparatus includes: an axis setting unit for setting a first axis used for estimating the eye opening degree in an eye region image including an eye whose opening degree is to be estimated; a first histogram generating unit for generating a first histogram as a function expressing a distribution of integrated values in the direction of the first axis by integrating luminance values of the eye region image, in different positions in the direction of the first axis along the direction perpendicular to the first axis; a feature amount deriving unit for deriving a feature amount of at least one of the first histogram and the eye region image, in the position in the direction of the first axis in which the first histogram has an extreme value; and an estimating unit for estimating the opening degree of an eye included in the eye region image on the basis of the feature amount. Since the opening degree of an eye is estimated on the basis of a feature amount in which the eye opening degree is reflected, the eye opening degree can be estimated with high precision while avoiding the influence of tilting of a face and glasses.

Preferably, in the eye opening degree estimating apparatus, the axis setting unit includes: a second histogram generating unit for generating a second histogram as a function expressing a distribution of integrated values in the direction of the second axis by integrating luminance values of the eye region image, in different positions in the direction of the second axis along the direction perpendicular to the second axis; and a determining unit for determining the position of the first axis in the direction of the second axis on the basis of a position in the direction of the second axis in which the second histogram has an extreme value. Since the first axis can be properly set, the eye opening degree can be estimated with higher precision.

Preferably, in the eye opening degree estimating apparatus, the first axis setting unit detects a principal axis of inertia almost perpendicular to open/close directions of an eyelid of an eye whose opening degree is to be estimated, and sets the first axis in parallel with the principal axis of inertia. Even in the case where the eyes are not in the horizontal direction or a face tilts, the first axis can be set in parallel with the principal axis of inertia. Thus, the eye opening degree can be estimated with higher precision.

The present invention is also directed to an eye opening degree estimating method of estimating the opening degree of eyes of a human.

Therefore, an object of the present invention is to provide an eye opening degree estimating apparatus and method capable of properly estimating the eye opening degree while eliminating the influence of tilting of a face and glasses.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the hardware configuration of eye opening degree estimating apparatuses 1A to 1C according to preferred embodiments of the present invention;

FIG. 2 is a block diagram showing the functional configuration of an image processing computer 20;

FIG. 3 is a block diagram showing the configuration of a face region detector 25;

FIG. 4 is a block diagram showing the configuration of an eye region analyzer 26;

FIG. 5 is a diagram illustrating an eye region which is set in a detection frame FR;

FIG. 6 is a diagram showing a search axis SA set in an eye region image ERI;

FIG. 7 is a flowchart showing operation of the face region detector 25;

FIG. 8 is a flowchart showing operation of the eye region analyzer 26.

FIG. 9 is a block diagram showing the detailed configuration of an eye region analyzer 36;

FIG. 10 is a diagram showing an eyebrow candidate area EBA in the eye region image ERI;

FIG. 11 is a flowchart showing operation of the eye region analyzer;

FIG. 12 is a flowchart showing the operation of determining a y coordinate of the search axis SA;

FIG. 13 is a block diagram showing a detailed configuration of an eye region analyzer 46;

FIG. 14 is a flowchart showing operation of the eye region analyzer 46; and

FIG. 15 is a diagram showing a state where the direction (x axis direction) of the search axis SA is set in the direction of the principal axis of inertia almost perpendicular to the direction of opening/closing of an eyelid of an eye whose opening degree is to be estimated.

### DESCRIPTION OF THE PREFERRED EMBODIMENTS

### 1. First Preferred Embodiment

1.1. Hardware Configuration

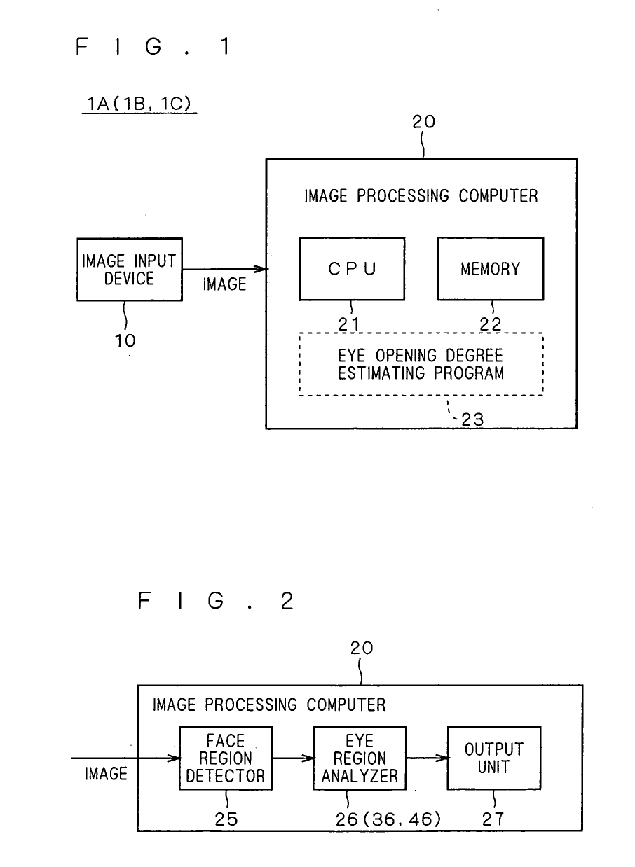

FIG. 1 is a block diagram showing the hardware configuration of an eye opening degree estimating apparatus 1A according to a first preferred embodiment of the present invention.

As shown in FIG. 1, the eye opening degree estimating apparatus 1A has an image input device 10 and an image processing computer 20. The image input device 10 is, for example, a digital camera or a scanner and generates and outputs an image. The image processing computer 20 is a computer having at least a CPU 21 and a memory 22, executes an eye opening degree estimating program 23 installed, and estimates the eye opening degree from a given image. The image input device 10 and the image processing computer 20 are connected so as to be able to perform communications. An image (image data) to be processed by the image processing computer 20 is given from the image input device 10 to the image processing computer 20. An image may be given to the image processing computer 20 by making the image processing computer 20 read a recording medium on which an image is recorded, or an image may be given to the image processing computer 20 via an electric communication line.

1.2. Functional Configuration of Image Processing Computer

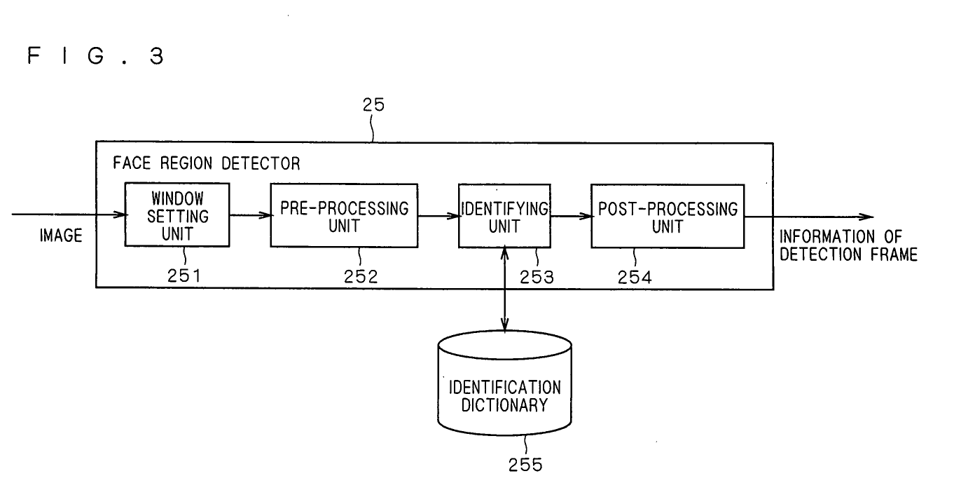

FIG. 2 is a block diagram showing the functional configuration of the image processing computer 20. A face region detector 25, an eye region analyzer 26, and an output unit 27 are functions realized when the CPU 21 and the memory 22 execute the eye opening degree estimating program 23 in cooperation with each other. Obviously, all or part of the functions may be realized by hardware which is a dedicated image processor.

Referring to FIG. 2, the face region detector 25 detects a face region in an input image and outputs information of a detection frame including the face region to the eye region analyzer 26.

The eye region analyzer 26 estimates the opening degree of an eye from the image of the eye region (hereinafter, also referred to as “eye region image”) including an eye whose opening degree is to be estimated in the input detection frame. Further, the eye region analyzer 26 estimates the eye opening degree in all of a plurality of input images and specifies an input image including the eyes opened widest.

The output unit 27 visibly displays the result of analysis of the eye region analyzer 26 on the input image including the eyes opened widest and the like on, for example, a display provided for the image processing computer 20.

In the following, the more detailed configuration of the face region detector 25 and the eye region analyzer 26 will be described.

1.2.1. Face Region Detector

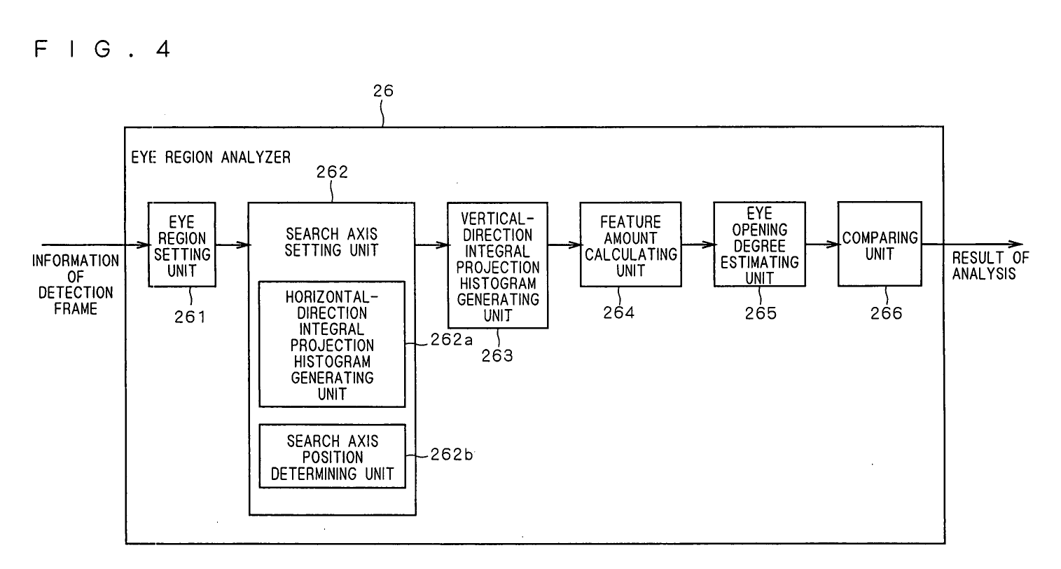

FIG. 3 is a block diagram showing the detailed configuration of the face region detector 25. In the following, functional blocks shown in FIG. 3 will be described one after another.

Window Setting Unit

A window setting unit 251 sets a rectangular window in an input image. The window setting unit 251 can variably set the position of the window in an input image and, desirably, variably set the size of the window relative to an input image. The size of the window relative to an input image may be changed by changing the size of the window or enlarging or reducing an input image while maintaining the size of the window constant. In the latter case, it is preferable to change the size of the window relative to an input image by properly setting the window in images of various sizes included in an image pyramid obtained by sub-sampling the input image. In the following description, it is assumed that images constructing the image pyramid are scanned with the window by moving the window in the images constructing the image pyramid. By enabling the size of the window relative to the input image to be changed, even when the size of a face included in the input image changes, identifying operation in an identifying unit 253 which will be described later can be properly executed.

Pre-Processing Unit

A pre-processing unit 252 performs a masking process on the window set by the window setting unit 251. In the masking process, a mask for removing image information of the periphery of the window, including the background which is not related to the features of a face, is applied to the window. Further, the pre-processing unit 252 makes pre-determination of whether an image of a part that is not masked (hereinafter, also referred to as an “unmasked part”) in the window is an image of a face region of a human or not, discards a window having the image of the unmasked part which is not determined as an image of a face region (that is, the image of the unmasked part is an image of a non-face region) to exclude the window from objects of the following processes. The pre-processing unit 252 normalizes luminance of a window which is not discarded by the pre-determination. As normalization of luminance, plane fitting normalization that corrects the luminance gradient, histogram equalization for equalizing histogram so that the same number of pixels are assigned to all of luminance values, or the like can be performed.

Identifying Unit

The identifying unit 253 identifies whether the image in the unmasked part is the image of the face region or not. More concretely, the identifying unit 253 vectorizes the image in the unmasked part and projects an obtained vector to a feature space for identification which is prepared. Further, the identifying unit 253 determines whether the image in the unmasked part as the base of the vector is an image of a face region or not on the basis of the result of projection of the vector, and outputs the position and size of the window having the image in the unmasked part which is determined to be the image of the face region to a post-processing unit 254.

As the feature space for identification, a principal component space obtained by performing principal component analysis (PCA) on vectors related to a number of images which are already determined as images of the face region can be used. Therefore, the feature space for identification is formed as a partial space in which the result of projecting the vector related to the image of the face region and that of projecting the vector related to the non-face region are largely different from each other. Whether an image is an image of the face region or not is determined on the basis of, for example, the magnitude relation between the distance to the feature space of the vector related to the image in the unmasked part and a predetermined threshold. Information necessary for the identifying process in the identifying unit 253 is pre-stored in an identification dictionary 255.

Post-Processing Unit

The post-processing unit 254 sets a detection frame on the basis of the position and size of an input window, and outputs the position and size of the set detection frame to the eye region analyzer 26. More concretely, for a window around which other windows do not exist, the post-processing unit 254 sets a detection frame whose position and size coincide with the position and size of the window. For a window around which other windows exist, the post-processing unit 254 sets a detection frame for unifying the plurality of neighboring windows. The position and size of the detection frame obtained after unification are an average value of the positions and an average value of the sizes of the plurality of windows before unification. With respect to a plurality of detection frames overlapped each other, only one detection frame is selected on the basis of a distance to a feature space or the like of a vector related to an image of the inside the detection frame, and the remaining detection frames are discarded as erroneous detection.

1.2.2. Eye Region Analyzer

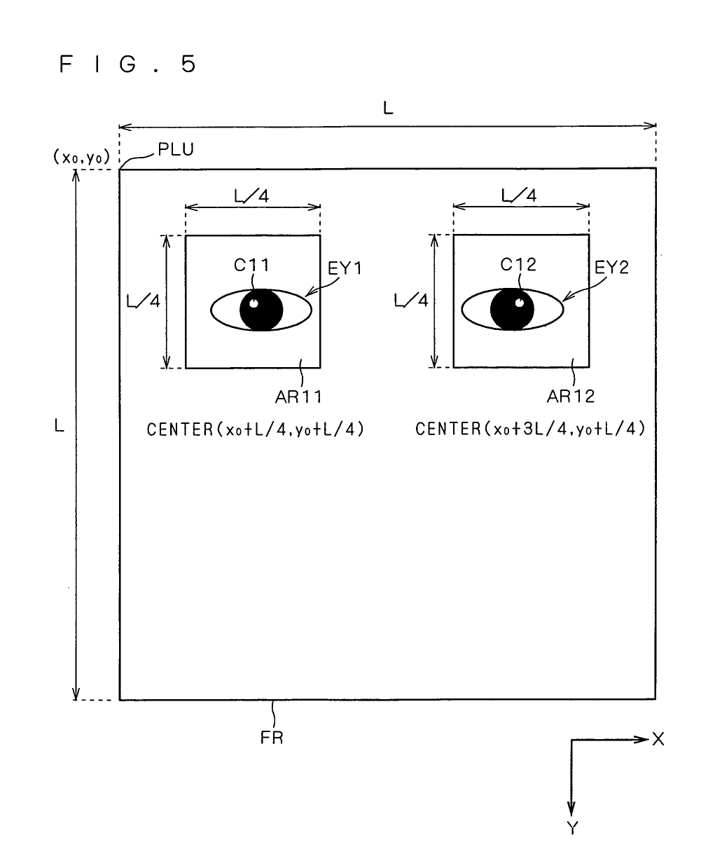

FIG. 4 is a block diagram showing the detailed configuration of the eye region analyzer 26 according to the first preferred embodiment. In the following, the functional blocks shown in FIG. 4 will be described one by one.

Eye Region Setting Unit

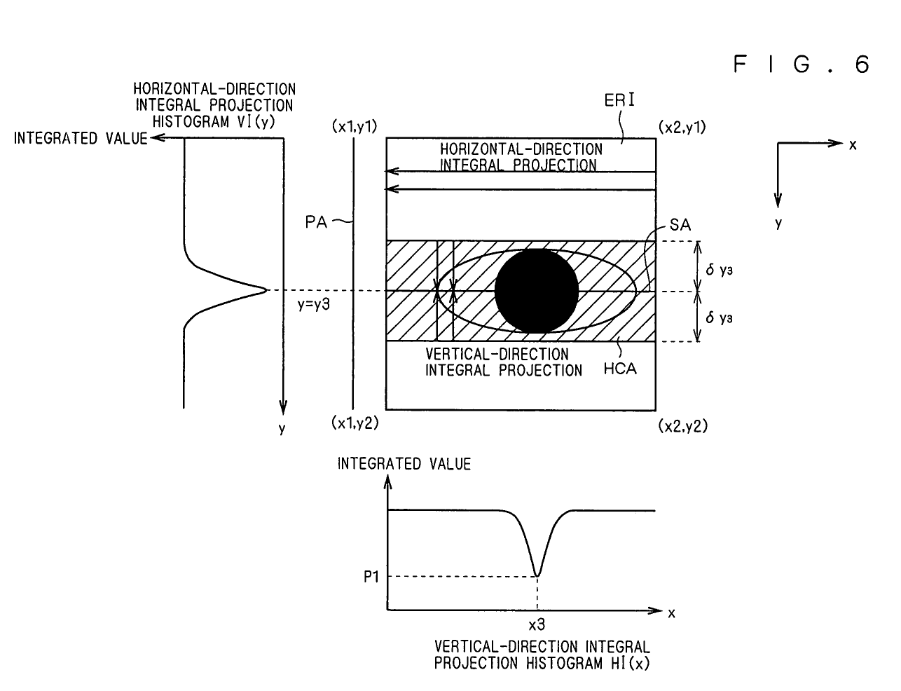

An eye region setting unit 261 sets an eye region of an eye whose opening degree is to be estimated in the detection frame that is set by the face region detector 25. For example, in the case where a square-shaped detection frame FR in which coordinates of a point PLU at the left upper corner are (Xo, Yo) and length of one side is L is set by the face region detector 25 as shown in FIG. 5 in which an XY orthogonal coordinate system whose X axis extends in the horizontal (lateral) direction and whose Y axis extends in the vertical (longitudinal) direction is defined, the eye region setting unit 261 sets a square-shaped eye region AR11 in which the position (coordinates) of a center C11 is (xo+L/4, yo+L/4) and length of one side is L/4 and which includes a right eye EY1, and a square-shaped eye region AR12 in which the position (coordinates) of a center C12 is (xo+3L/4, yo+L/4) and length of one side is L/4 and which includes the left eye EY2. In such a manner, in the eye opening degree estimating apparatus 1A, the eye region images are extracted from an input image. The positions of the centers C11 and C12 of the eye regions AR11 and AR12 relative to the detection frame FR and the sizes of the eye regions AR11 and AR12 relative to the detection frame FR are predetermined.

By enlarging the eye regions AR11 and AR12, the possibility that the eyes EY1 and EY2 whose opening degrees to be estimated are included in the eye regions AR11 and AR12 increases. However, a computing amount for generating an integral projection histogram which will be described later increases and time required to estimate the eye opening degree becomes longer. On the other hand, when the eye region is reduced, the computation amount for generating an integral projection histogram which will be described later decreases and time required for estimating the eye opening degree becomes shorter. However, the possibility that the eyes EY1 and EY2 whose opening degrees are to be estimated are included in the eye regions AR11 and AR12 becomes lower. Consequently, it is desired to reduce the eye regions AR11 and AR12 as much as possible within the range where the eyes EY1 and EY2 whose opening degree is to be estimated are included with reliability.

Search Axis Setting Unit

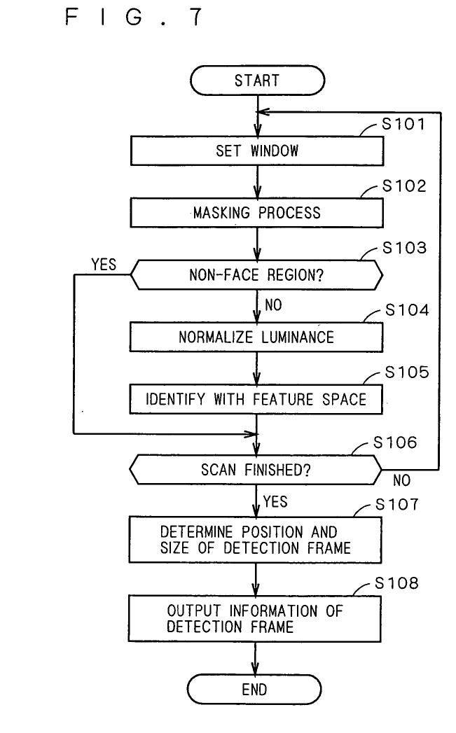

A search axis setting unit 262 sets a search axis used for estimating the eye opening degree in an eye region image. Further, the search axis setting unit 262 sets, in addition to the search axis, a position determination axis used for determining the position of the search axis in the eye region images. The position determination axis is set in a direction perpendicular to the direction in which the search axis is to be set. Although the directions of setting the search axis and the position determination axis are not always limited, in the following, it is assumed that, as shown in FIG. 6 defining an XY orthogonal coordinate system using the horizontal axis as the X axis and the perpendicular direction as the Y axis, the search axis SA is set in the X axis direction (horizontal direction) and the position determination axis PA is set in the Y axis direction (perpendicular direction) in the rectangular eye region image ERI whose apexes are in coordinates (x₁, y₁), (x₁, y₂), (x₂, y₂), and (x₂, y₁) (where x₁<x₂, and y₁<y₂). Therefore, in the following, a position in the direction of the search axis SA is expressed by the x coordinate and a position in the direction of the position determination axis PA is expressed by the y coordinate.

Referring again to FIG. 4, more specifically, the search axis setting unit 262 has a horizontal-direction integral projection histogram generating unit 262a and a search axis position determining unit 262b.

The horizontal-direction integral projection histogram generating unit 262a integrates luminance values I(x,y) of the eye region image ERI in different positions in the Y axis direction along the X axis direction, thereby generating a horizontal-direction integral projection histogram VI(y) as a function expressing distribution of integrated values in the Y axis direction as shown by Equation (1). The luminance value I(x,y) indicates the luminance value at the coordinates (x, y).

$$VI ( y ) = {\int }_{x 1}^{x 2} I ( x , y ) ⅆ x \qquad ( 1 )$$

As obvious from Equation (1), the horizontal-direction integral projection histogram VI(y) is obtained by integrating the luminance values I(x, y) of the entire eye region image ERI.

The search axis position determining unit 262b determines the y coordinate of the search axis SA on the basis of the horizontal-direction integral projection histogram VI(y). More concretely, in the case where there is one y coordinate in which the horizontal-direction projection histogram VI(y) has the local minimum, the search axis position determining unit 262b determines the y coordinate as the y coordinate of the search axis SA. In the case where there are a plurality of y coordinates in which the horizontal-direction projection histogram VI(y) has the local minimum, the search axis position determining unit 262b determines the maximum y coordinate among the y coordinates as the y coordinate of the search axis SA. This utilizes the fact such that the possibility that the y coordinate in which the horizontal-direction integral projection histogram VI(y) has the local minimum coincides with the y coordinate in the center of an eye is high since a part of black (or a dark color) having an almost circular shape exists in the center portion of an eye of a human.

Vertical-Direction Integral Projection Histogram Generating Unit

A vertical-direction integral projection histogram generating unit 263 integrates luminance values I(x,y) of the eye region image ERI in different positions in the X axis direction along the Y axis direction, thereby generating a vertical-direction integral projection histogram HI(x) as a function expressing distribution of integrated values in the X axis direction as shown by Equation (2).

$$HI ( x ) = {\int }_{ y 3 - δ y 3}^{y 3 + δ y 3} I ( x , y ) ⅆ y \qquad ( 2 )$$

As obvious from Equation (2), the vertical-direction integral projection histogram HI(x) is obtained by integrating the luminance values I(x, y) in a band-shaped histogram calculation area HCA using the search axis y=y₃ as a center within a distance δy₃ from the search axis y=y₃. Desirably, a concrete value of the distance δy₃ is set to, for example, about L/6.

Feature Amount Calculating Unit

A feature amount calculating unit 264 derives a feature amount P₁ in which the opening degree of an eye is reflected on the basis of the vertical-direction integral projection histogram HI(x). More concretely, the feature amount calculating unit 264 specifies an x coordinate X₃ in which the vertical-direction integral projection histogram HI(x) has the local minimum and derives the value (local minimum) of the vertical-direction integral projection histogram HI(x) in the x coordinate X₃ as the feature amount P₁ as shown by Expression (3).
P₁=HI(x₃) (3)
Eye Opening Degree Estimating Unit

An eye opening degree estimating unit 265 estimates an opening degree P of an eye included in the eye region image ERI on the basis of the feature amount P₁ derived by the feature amount calculating unit 264. In the first preferred embodiment, the feature amount P₁ itself is dealt as the eye opening degree P. The value of the eye opening degree P decreases as the opening degree of the eye increases.

Comparing Unit

A comparing unit 266 compares estimated eye opening degrees P of eye region images ERI extracted from a plurality of input images with each other, specifies an input image including the most-opened eye (having the smallest eye opening degree P), and outputs the input image as an analysis result.

1.3. Operation

Next, as the operations of the eye opening degree estimating apparatus 1A, the operation of the face region detector 25 and the operation of the eye region analyzer 26 will be described in order.

Operation of Face Region Detector

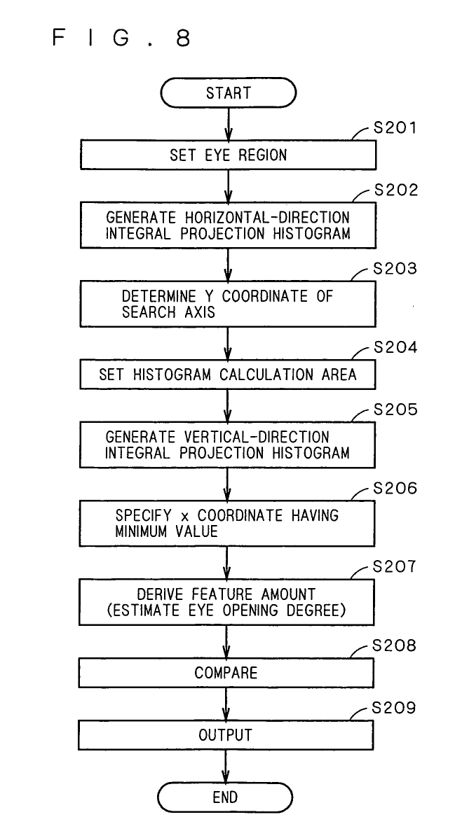

FIG. 7 is a flowchart showing operation of the face region detector 25.

Steps S101 to S106 in FIG. 7 are a step group for specifying the position and size of a window in which an image of a non-mask part is an image of a face region.

When an image is input from the image input device 10, in the face region detector 25, a window is set in the input image by the window setting unit 251 (step

Subsequently, by the pre-processing unit 252, a process of masking the set window is performed (step S102), and pre-determination for discarding a window in which the image in the non-mask part is an image of the non-face region is made (step S103). In the case where the image in the non-mask part is determined as an image in the non-face region in step S103, the program moves to step S106 without executing the following steps S104 and S105. On the other hand, in the case where the image in the non-mask part is not determined as an image in the non-face region, steps S104 and S105 are sequentially executed and, after that, the program moves to step S106. As described above, by executing the pre-determination (step S103) prior to identification using a feature space (step S105), it becomes unnecessary to perform the identification using a feature space on a window in which the image in the non-mask part is clearly an image of a non-face region, so that the load on the image processing computer 20 can be lessened. To realize reduction in the load, the pre-determination has to be a process which can be executed with load lighter than that of the identification using the feature space. Consequently, in the pre-determination, for example, a simple determining method based on the relation between the proportion of pixels of skin color included in the image of the non-mask part and a predetermined threshold is used.

In step S104, the luminance of the image in the non-mask part in the window which is not discarded in step S103 is normalized by the pre-processing unit 252. In step S105, whether the image in the non-mask part is an image in the face region or not is determined by using the feature space by the identifying unit 253. The position and size of the window in which the image in the non-mask part is determined as an image in the face region are stored in the memory 22.

In step S106, the process is branched according to whether scan of the window of the whole input image has completed or not. In the case where the scan completes, the program moves to step S107. In the case where the scan has not completed, the program moves to step S101 where the position of the window is changed and the processes in step S101 to S106 are newly performed.

Subsequently, the position and the size of the detection frame FR are determined on the basis of the position and the size of the window in which the image in the non-mask part is identified as an image of the face region by the post-processing unit 254 (step S107), the determined information of the detection frame FR is output to the eye region analyzer 26 (step S108) and, after that, the operation of the face region detector 25 is finished.

Operation of Eye Region Analyzer

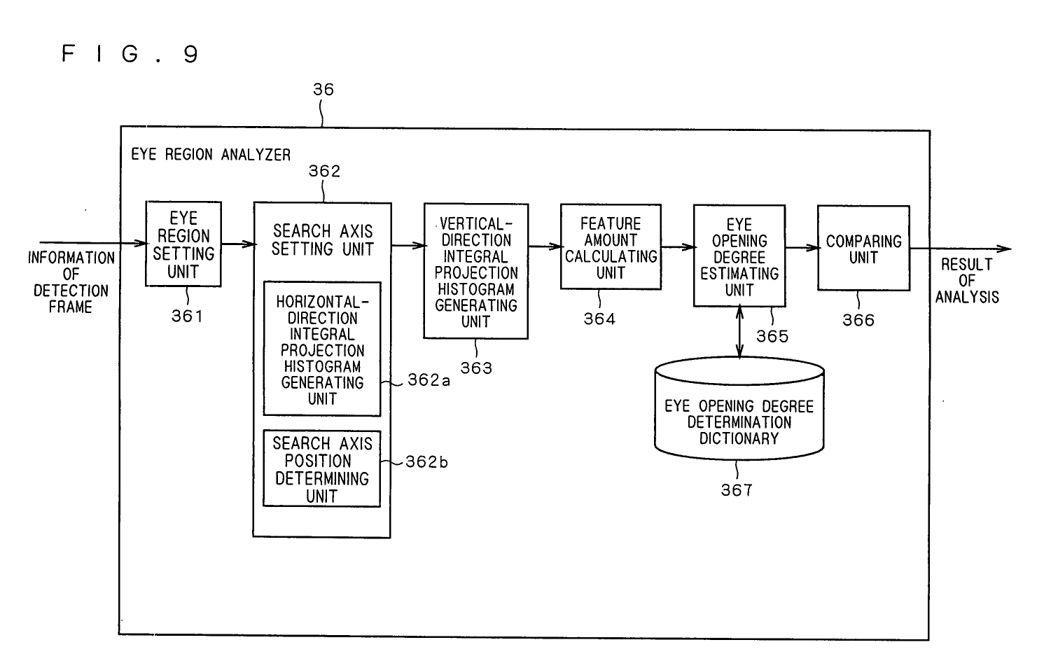

FIG. 8 is a flowchart showing the operation of the eye region analyzer 26.

As shown in FIG. 8, when the information of the detection frame FR is input from the face region detector 25, in the eye region analyzer 26, the eye regions AR11 and AR12 are set in the detection frame FR by the eye region setting unit 261 (step S201).

Steps S202 and S203 subsequent to step S201 are a step group for setting the search axis SA by the search axis setting unit 262. At the time of setting the search axis SA, first, the horizontal-direction integral projection histogram VI(y) is generated by the horizontal-direction integral projection histogram generating unit 262a (step S202). The y coordinate of the search axis SA is determined by the search axis position determining unit 262b on the basis of the y coordinate in which the horizontal-direction integral projection histogram VI(y) has the local minimum (step S203).

Subsequently, the histogram calculation area HCA is set by the vertical-direction integral projection histogram generating unit 263 (step S204). By integrating the luminance values I(x,y) in the histogram calculation area HCA, a vertical-direction integral projection histogram HI(x) is generated (step S205).

Further, the x coordinate x₃ in which the vertical-direction integral projection histogram HI(x) has the local minimum is specified by the feature amount calculating unit 264 (step S206), and a value HI(x₃) of the vertical-direction integral projection histogram HI(x) in the x coordinate X₃ is derived as the feature amount P₁ (step S207). As described above, the feature amount P₁ also serves as the eye opening degree P. In step S206, by using the fact such that the possibility that the x coordinate X₃ in which the horizontal-direction integral projection histogram HI(x) has the local minimum coincides with the x coordinate in the center of the eye is high, the behavior of the vertical-direction integral projection histogram HI(x) in the position of the center of an eye is employed as the feature amount P₁.

Since the eye opening degree P is estimated on the basis of the feature amount P₁ in which the eye opening degree is reflected in the eye opening degree estimating apparatus 1A, the eye opening degree can be estimated with high precision while avoiding the influence of tilting of a face and glasses. In addition, since the y coordinate of the search axis SA is variably set by the search axis setting unit 262, the search axis SA can be properly set in the position of the center of an eye, and the eye opening degree estimating apparatus 1A can estimate the eye opening degree with high precision.

In addition, it is unnecessary to separately perform determination of the position of the center of an eye and estimation of the eye opening degree P in the above-described operation flow, so that the load on the image processing computer 20 can be reduced. Further, the eye opening degree P can be properly estimated even if the eye region image ERI is slightly deviated from the eye in the operation flow, so that the eye regions AR11 and AR12 can be easily set.

Further, in the eye opening degree estimating apparatus 1A, an image in which the eye opening degree P is the minimum is specified by the comparison of the eye opening degrees P among the eye region images ERI extracted from a plurality of input images in the comparing unit 266 (step S208). The specified image is output as the analysis output from the output unit 27 (step S209). Consequently, only by giving a plurality of images, the eye opening degree estimating apparatus 1A can automatically specify and output an image with the eyes open widest.

### 2. Second Preferred Embodiment

An eye opening degree estimating apparatus 1B according to a second preferred embodiment of the present invention has a configuration similar to that of the eye opening degree estimating apparatus 1A according to the first preferred embodiment except that the detailed configuration of an eye region analyzer 36 is different from that of the eye region analyzer 26 of the first preferred embodiment. In the following, the detailed configuration and operation of the eye region analyzer 36 will be described and the configuration and operation similar to those of the eye opening degree estimating apparatus 1A will not be repeated.

2.1. Detailed Configuration of Eye Region Analyzer

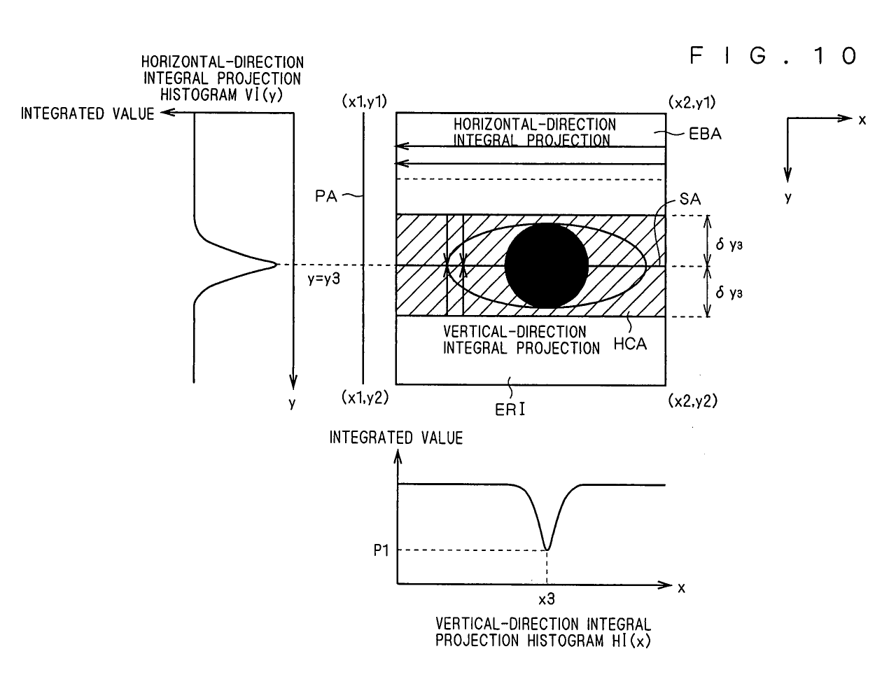

FIG. 9 is a block diagram showing the detailed configuration of the eye region analyzer 36.

Among functional blocks shown in FIG. 9, a search axis position determining unit 362b (search axis setting unit 362), a feature amount calculating unit 364, an eye opening degree estimating unit 365, and a comparing unit 366 have functions different from those of the search axis position determining unit 262b (search axis setting unit 262), the feature amount calculating unit 264, the eye opening degree estimating unit 265, and the comparing unit 266 of the first preferred embodiment. An eye region setting unit 361 and a vertical-direction integral projection histogram generating unit 363 as the other functional blocks have functions similar to those of the eye region setting unit 261 and the vertical-direction integral projection histogram generating unit 263 as the corresponding functional blocks in the first preferred embodiment. In the following, the search axis position determining unit 362b, feature amount calculating unit 364, and comparing unit 366 will be described one by one but the description of the other functional blocks will not be repeated. Search axis position determining unit

Like the search axis position determining unit 262b, the search axis position determining unit 362b determines the y coordinate of the search axis SA on the basis of the horizontal-direction integral projection histogram VI(y). The search axis position determining unit 362b is different from the search axis determining unit 262b with respect to the point that the y coordinate of the search axis SA is determined in consideration of the influence of the eyebrows and glasses in more detail.

More concretely, the search axis position determining unit 362b determines which one of the position of an eyebrow, the position of the center of an eye, and the position of the frame of glasses the y coordinate in which the horizontal-direction integral projection histogram VI(y) has the extreme value corresponds in consideration of the relations among a plurality of extreme values of the horizontal-direction integral projection histogram VI(y).

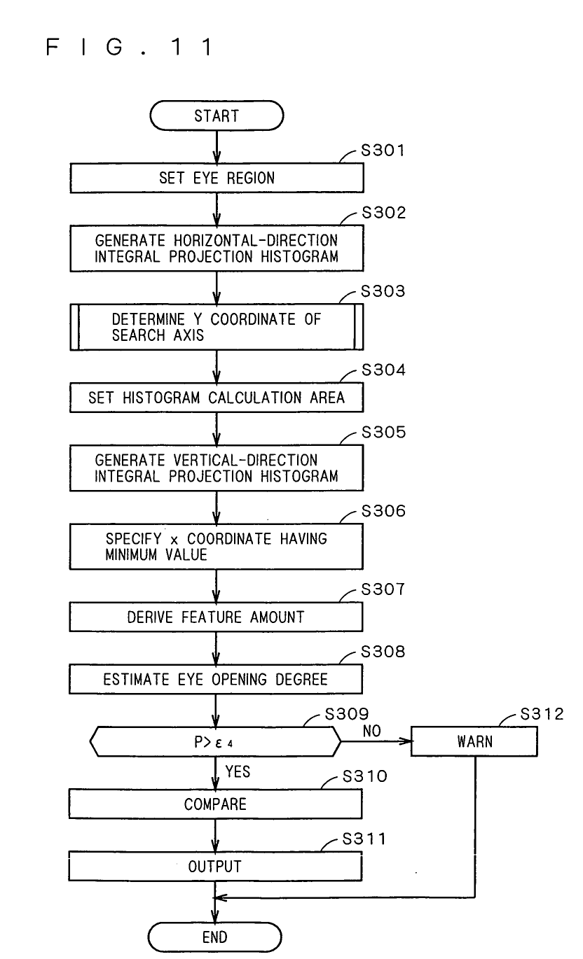

In particular, in the case where the region of the quarter from the upper end of the eye region image ERI is regarded as the eyebrow candidate region EBA as shown in FIG. 10 and the y coordinate in which the horizontal-direction projection histogram VI(y) has the global minimum (the smallest value among a plurality of local minimums) is included in the eyebrow candidate area EBA, the search axis position determining unit 362b examines the relation between the global minimum and the other local minimums and, if the possibility that the y coordinate corresponds to the position of the eyebrow is high, sets the y coordinate in which the histogram has another local minimum as the y coordinate of the search axis SA.

Feature Amount Calculating Unit

The feature amount calculating unit 364 derives a plurality of feature amounts P₁ to P₃ in which the eye opening degree is reflected on the basis of the vertical-direction integral projection histogram HI(x). More concretely, the feature amount calculating unit 364 calculates, in addition to the feature amount P₁ similar to that in the first preferred embodiment, the feature amount P₂ as an index value of the uneven state of the vertical-direction integral projection histogram HI(x) in the x coordinate X₃ in which the vertical-direction integral projection histogram HI(x) has the local minimum on the basis of Equation (4).

$${P}_{2} = \vert \frac{{ⅆ}^{2} HI ( {x}_{3} )}{ⅆ {x}^{2}} \vert \qquad ( 4 )$$

Further, the feature amount calculating unit 364 calculates the feature amount P₃ of the eye region image ERI in the x coordinate X₃ in addition to the feature amounts P₁ and P₂ of the vertical-direction integral projection histogram HI(x) in the x coordinate x₃. As the feature amount P₃, for example, the number of black pixels at x=x₃ in the histogram calculation area HCA shown in FIG. 10 can be employed.

Eye opening degree estimating unit

The eye opening degree estimating unit 365 estimates the opening degree P of the eye included in the eye region image ERI on the basis of the feature amounts P₁ to P₃ derived by the feature amount calculating unit 364. For example, the eye opening degree estimating unit 365 estimates the eye opening degree P by assigning weights to the feature amounts P₁ to P₃ with a weight constant ωᵢ and executing addition as shown by Equation (5).

$$P = {\sum }_{i = 1}^{3} {ω}_{i} {P}_{i} \qquad ( 5 )$$

The weight constant ωᵢ included in Equation (5) is preliminarily determined by conducting multiple regression analysis using feature amounts Pᵢ^{j} derived from N pieces of eye region images (sample images) whose eye opening degrees are known as independent variables and using known eye opening degrees hⱼ(i=1, 2, 3; j=1, 2, . . . N) of the sample images as dependent variables. The weight constant ωᵢ is stored in an eye opening degree determination dictionary 367. That is, the weight constant ωᵢ is determined so as to minimize target function E shown in the right side of the equation (6) and stored in the eye opening degree determination dictionary 367.

$$E = {\sum }_{i = 1}^{3} {ω}_{i} {P}_{i} \qquad ( 5 )$$

Alternately, the weight constant ωᵢ is specified by defining a weight vector Ω using the weight constant ωᵢ as a component, a feature amount matrix Q using the feature amount Pᵢ^{j} as a component, and an eye opening degree vector H using the weight constant hⱼ as a component, and calculating the weight vector Ω by Equation (8). T denotes transposition of matrix and −1 denotes inverse matrix.

$$\begin{matrix}Ω = [ \begin{matrix}{ω}_{1} \\ {ω}_{2} \\ {ω}_{3}\end{matrix} ] , \\ Ω = [ \begin{matrix}{P}_{1}^{2} ⋯ {P}_{1}^{N} \\ {P}_{2}^{1} ⋯ {P}_{2}^{N} \\ {P}_{3}^{1} ⋯ {P}_{3}^{N}\end{matrix} ] , \\ H = [ \begin{matrix}{h}_{1} \\ {h}_{2} \\ ⋮ \\ {h}_{N}\end{matrix} ] & ( 7 ) \\ Ω = {( {Q}^{T} Q )}^{- 1} {Q}^{T} H & ( 8 )\end{matrix}$$

Although the number of feature amounts is three in the above description, the eye opening degree P can be similarly estimated even when the number of feature amounts is two or four or larger.

Comparing Unit

Like the comparing unit 266, the comparing unit 366 compares the eye opening degrees P of a plurality of input images, specifies an input image including eyes open widest (the maximum eye opening degree P) by comparing the eye opening degrees P estimated from a plurality of eye region images ERI extracted from the plurality of input images, and outputs the specified input image as an analysis result. In addition, the comparing unit 366 compares the eye opening degree P with a predetermined threshold. Only when the eye opening degree P is larger than the threshold, it is used for comparison. If there is no input image having the eye opening degree P larger than the threshold, the information is output to the output unit 27 to display a warning message on a display or the like provided for the image processing computer 20.

2.2. Operation of Eye Region Analyzer

Operation of Eye Region Analyzer

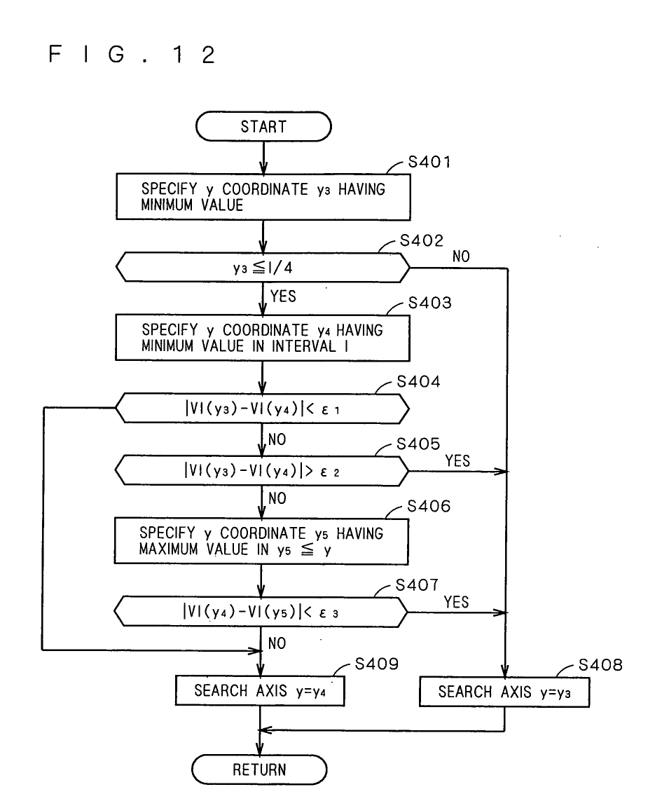

FIG. 11 is a flowchart showing the operation of the eye region analyzer 36.

As shown in FIG. 11, when information of the detection frame FR is input from the face region detector 25, in steps S301 and S302, the eye region analyzer 36 performs processes similar to those of steps S201 and S202.

The following step S303 is a subroutine in which the search-axis position determining unit 362b determines the y coordinate of the search axis SA. The subroutine will be described later.

Subsequently, processes similar to those in the steps S204 to S206 are performed in steps S304 to S306.

In step S307, the feature amounts P₁ and P₂ of the vertical-direction integral projection histogram HI(x) in the x coordinate in which the vertical-direction integral projection histogram HI(x) has the local minimum and the feature amount P₃ of the eye region image ERI are derived by the feature amount calculating unit 364.

In step S308, the eye opening degree P is estimated by the eye opening degree estimating unit 365.

In step S309, the eye opening degree P is compared with a predetermined threshold ε₄ by the comparing unit 366. In the case where the eye opening degree P is larger than the threshold ε₄ in step S309, in other words, in the case where an image in which the eyes of a person are open sufficiently wide exists, the program moves to step S310 where the eye region image ERI in which the eye opening degree P is larger than the threshold ε₄ is subjected to the comparing operation similar to that in step S208. On the other hand, when the eye opening degree P is smaller than the threshold ε₄, in other words, when there is no image in which eyes are open sufficiently wide, the information of the fact is sent to the output unit 27 to notify the operator of the absence of an image in which the eyes of a person are open sufficiently wide (step S312). Consequently, the operator can easily recognize that all of images are unsuccessful ones (with close eyes).

In step S311, a process similar to that in step S211 is performed.

As described above, the eye opening degree estimating apparatus 1B also estimates the eye opening degree P on the basis of the plurality of feature amounts P₁ to P₃ in which the eye opening degree is reflected, so that the eye opening degree P can be estimated with high precision while avoiding the influenced of tilting of a face and glasses. In addition, the y coordinate of the search axis SA is set variably by the search axis setting unit 362 also in the eye opening degree estimating apparatus 1B. Therefore, the search axis SA can be properly set to the center position of an eye, and the eye opening degree P can be estimated with high precision.

Further, the eye opening degree estimating apparatus 1B does not have to simultaneously perform determination of the center position of an eye and estimation of the eye opening degree P. Thus, the load of the image processing computer 20 can be reduced. Even when the eye region image ERI is slightly deviated from an eye, the eye opening degree P can be properly estimated by the operation flow. Consequently, the eye regions AR11 and AR12 can be easily set.

Further, only by supplying a plurality of images, the eye opening degree estimating apparatus 1B can also automatically specify and output an image in which the eyes are open widest.

Determination of y Coordinate of Search Axis (Subroutine)

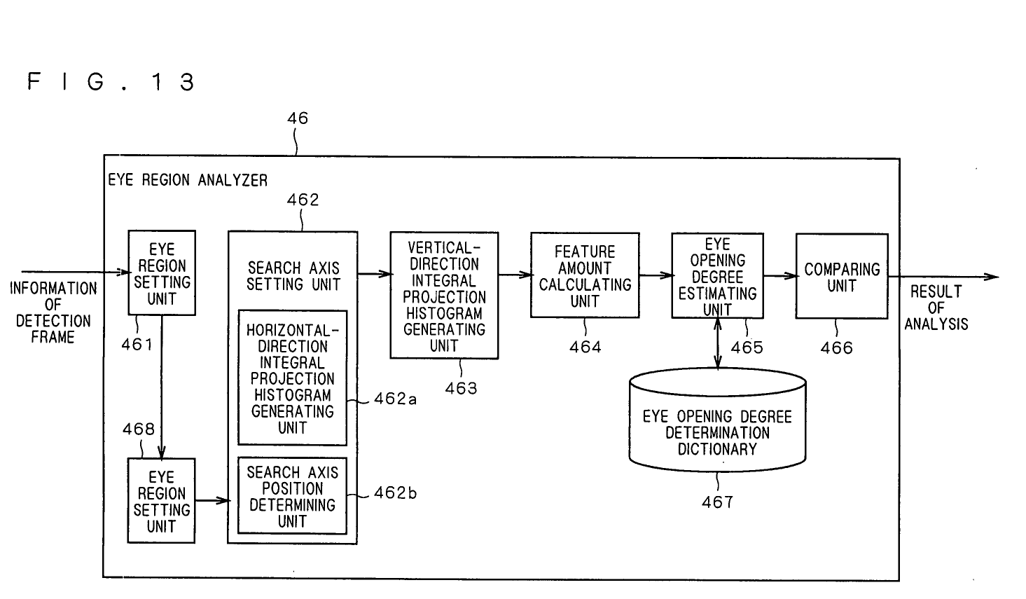

The operation of determining the y axis of the search axis SA (subroutine) in step S303 will now be described with reference to the flowchart of FIG. 12. In the following, it is assumed that the point at the left upper corner of the eye region image ERI is the origin of a coordinate system.

In the subroutine, first, the y coordinate y₃ in which the histogram has the global minimum is specified, and whether the y coordinate y₃ is included in the eyebrow candidate area EBA or not is determined. That is, whether the conditional equation (9) is satisfied or not is determined. In the case where the conditional equation (9) is satisfied, the possibility that the y coordinate y₃ corresponds to the position of an eyebrow is high, so that further determination is made in/after step S403. If the conditional equation is not satisfied, the y coordinate y₃ is determined as the y coordinate of the search axis SA (step S408), and the subroutine is finished.
Y₃≦¼ (9)

In step S403, a y coordinate y₄ in which the horizontal projection integral histogram VI(y) has the local minimum in the range of the width δb on the lower side of the y coordinate y₃, that is, in the interval I=[y₃, y₃+δb] is specified. In step S404, the difference of the values of the horizontal projection integral histogram VI(y) in the y coordinates y₃ and y₄ is compared with the threshold ε₁ and whether the conditional equation (10) is satisfied or not is determined.
|VI(y₃)−VI(y₄)|<ε₁ (10)

In the case where the conditional equation (10) is satisfied, the horizontal projection integral histogram VI(y) sufficiently decreases in the y coordinate y₄, so that the possibility that the y coordinate y₄ corresponds to the y coordinate in the center of an eye is considered to be high. Consequently, the y coordinate y₄ is determined as the y coordinate of the search axis SA (step S409), and the subroutine is finished. On the other hand, when the conditional equation (10) is not satisfied, the difference between the value of the horizontal projection integral histogram VI(y) in the y coordinate y₃ and the value of the horizontal projection integral projection histogram VI(y) in the y coordinate y₄ is compared with a predetermined threshold ε₂, and whether the conditional equation (11) is satisfied or not is determined.
|VI(y₃)−VI(y₄)|>ε₂ (11)

In the case where the conditional equation (11) is satisfied, the horizontal projection integral histogram VI(y) does not sufficiently decrease in the y coordinate y₄, so that the possibility that the y coordinate y₄ is in the position corresponding to the frame of glasses or error detection occurs due to noise is high. Consequently, the y coordinate y₃ is determined as the y coordinate of the search axis SA (step S408), and the subroutine is finished. On the other hand, when the conditional equation (11) is not satisfied, further determination is made in/after step S406.

After that, a y coordinate y₅ in which the horizontal projection integral histogram VI(y) has the local maximum in a lower part of the y coordinate y₄ is specified (step S406). The difference of the values of the horizontal projection integral histogram VI(y) in the y coordinates y₄ and y₅ is compared with the predetermined threshold ε₃ and whether the conditional equation (12) is satisfied or not is determined.
|VI(y₄)−VI(y₅)|<ε₃ (12)

In the case where the conditional equation (12) is satisfied, the horizontal projection integral histogram VI(y) does not sufficiently decrease in the y coordinate y₄, so that the possibility that the y coordinate y₄ is in the position corresponding to the frame of glasses is considered to be high. Consequently, the y coordinate y₃ is determined as the y coordinate of the search axis SA (step S408), and the subroutine is finished. On the other hand, when the conditional equation (12) is not satisfied, the horizontal projection integral histogram VI(y) sufficiently decreases in the y coordinate y₄, so that the possibility that the y coordinate y₄ corresponds to the y coordinate in the center of an eye is considered to be high. Therefore, the y coordinate y₄ is determined as the y coordinate of the search axis SA (step S409), and the subroutine is finished.

### 3. Third Preferred Embodiment

An eye opening degree estimating apparatus 1C according to a third preferred embodiment of the present invention has a configuration similar to that of the eye opening degree estimating apparatus 1B of the second preferred embodiment but the detailed configuration of an eye region analyzer 46 is different from that of the eye region analyzer 36 of the first preferred embodiment. In the following, the detailed configuration and operation of the eye region analyzer 46 will be described but the description of the configuration and operation similar to those of the eye opening degree estimating apparatus 1B will not be repeated.

3.1. Detailed Configuration of Eye Region Analyzer

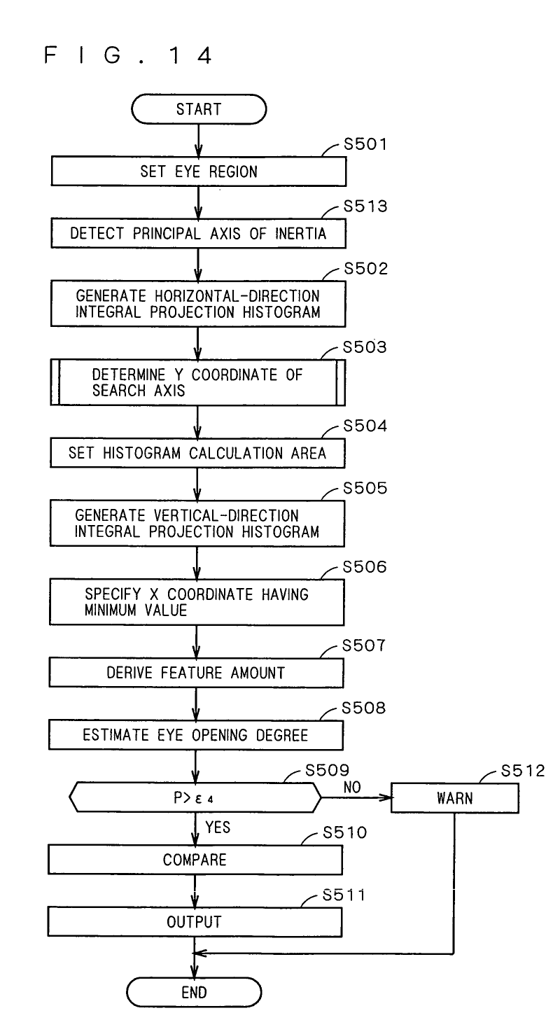

FIG. 13 is a block diagram showing a detailed configuration of the eye region analyzer 46.

As shown in FIG. 13, the eye region analyzer 46 has a principal axis setting unit 468 in addition to functional blocks similar to those of the eye region analyzer 36, which are an eye region setting unit 461, a search axis setting unit 462 (a horizontal-direction integral projection histogram generating unit 462a and a search axis position determining unit 462b), a vertical-direction integral projection histogram generating unit 463, a feature amount calculating unit 464, an eye opening degree estimating unit 465, a comparing unit 466, and an eye opening degree determination dictionary 467.

Although the search axis SA is set in the horizontal direction in the eye opening degree detecting apparatus 1B, in the eye opening degree estimating apparatus 1C, the search axis SA can be set in the direction of the principal axis of inertia almost perpendicular to the opening/closing direction of the eye lid of an eye whose opening degree is to be estimated. The principal axis setting unit 468 has the function of detecting the principal axis of inertia. Consequently, the search axis SA can be set in parallel with the principal axis of inertia also in the case where the eyes are not in the horizontal direction or the face tilts. Thus, the eye opening degree can be estimated with high precision.

3.2. Operation of Eye Region Analyzer

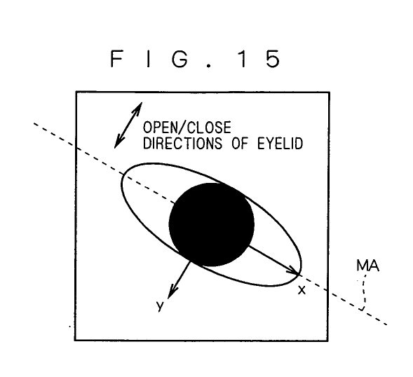

FIG. 14 is a flowchart showing the operation of the eye region analyzer 46.

In steps S501 to S512 in the flowchart of FIG. 14, processes similar to those in steps S301 to S312 in the flowchart of FIG. 11 are performed. In the flowchart of FIG. 14, prior to generation of the horizontal direction integral projection histogram VI(y) (step S502), a process of detecting the principal axis of inertia and setting the direction of the principal axis MA of inertia in the X axis direction as shown in FIG. 15 is performed (step S513). The principal axis MA of inertia is detected by specifying the direction in which the local minimum of the vertical-direction integral projection histogram HI(x) becomes the smallest while changing, for example, the direction of the search axis SA temporarily set.

Since the eye opening degree estimating apparatus 1C also estimates the eye opening degree P on the basis of the plurality of feature amounts P₁ to P₃ in which the eye opening degree is reflected, the eye opening degree can be estimated with high precision while avoiding the influence of tilting of a face and glasses. In addition, the y coordinate of the search axis SA is variable set by the search axis setting unit 462 also in the eye opening degree estimating apparatus 1C, the search axis SA can be properly set in the center position of the eye. Thus, the eye opening degree can be estimated with high precision.

In addition, it is unnecessary to separately perform determination of the position of the center of an eye and estimation of the eye opening degree P also in the eye opening degree estimating apparatus 1C, so that the load on the image processing computer 20 can be reduced. Further, the eye opening degree P can be properly estimated even if the eye region image ERI is slightly deviated from the eye in the operation flow, so that the eye regions AR11 and AR12 can be easily set.

Further, only by supplying a plurality of images, the eye opening degree estimating apparatus 1C can automatically specify and output an image in which the eyes are open widest.

Modifications

Since the horizontal-direction integral projection histogram generating unit 262a (362a, and 462a) and the vertical-direction integral projection histogram generating unit 263 (363 and 463) in the first to third preferred embodiments perform similar computation, the eye opening degree estimating apparatuses 1A to 1C may be constructed as a common functional block for these units. Similarly, since the search axis position determining unit 262b (362b and 462b) and the feature amount estimating unit 264 (364 and 464) perform similar computation, the eye opening degree estimating apparatuses 1A to 1C may be also constructed as a common functional block for these units.

While the invention has been shown and described in detail, the foregoing description is in all aspects illustrative and not restrictive. It is therefore understood that numerous modifications and variations can be devised without departing from the scope of the invention.

What is claimed is:

1. An eye opening degree estimating apparatus for estimating the opening degree of an eye of a human, comprising:
an axis setting unit for setting a first axis used for estimating the eye opening degree in an eye region image including an eye whose opening degree is to be estimated;
a first histogram generating unit for generating a first histogram as a function expressing a distribution of integrated values in the direction of said first axis by integrating luminance values of said eye region image, in different positions in the direction of said first axis along the direction perpendicular to said first axis;
a feature amount deriving unit for deriving a feature amount of at least one of said first histogram and said eye region image, in the position in the direction of said first axis in which said first histogram has an extreme value; and
an estimating unit for estimating the opening degree of an eye included in said eye region image on the basis of said feature amount.

2. The eye opening degree estimating apparatus according to claim 1, wherein
said axis setting unit includes:
a second histogram generating unit for generating a second histogram as a function expressing a distribution of integrated values in the direction of said second axis by integrating luminance values of said eye region image, in different positions in the direction of said second axis along the direction perpendicular to said second axis; and
a determining unit for determining the position of said first axis in the direction of said second axis on the basis of a position in the direction of said second axis in which said second histogram has an extreme value.

3. The eye opening degree estimating apparatus according to claim 1, wherein
said first axis setting unit detects a principal axis of inertia almost perpendicular to open/close directions of an eyelid of an eye whose opening degree is to be estimated, and sets said first axis in parallel with the principal axis of inertia.

4. The eye opening degree estimating apparatus according to claim 1, further comprising:
an extractor for extracting said eye region image from an input image, wherein
the opening degree of an eye in each of a plurality of eye region images extracted from a plurality of input images is estimated, and
an image including eyes which are open widest is specified.

5. The eye opening degree estimating apparatus according to claim 1, wherein
said feature amount deriving unit derives the local minimum of said first histogram as said feature amount.

6. The eye opening degree estimating apparatus according to claim 2, wherein
said determining unit determines the position of said first axis in the direction of said second axis on the basis of the position in the direction of said second axis in which said second histogram has the local minimum.

7. The eye opening degree estimating apparatus according to claim 2, wherein
when the absolute value of a difference between an extreme value within a range as an extreme value of said second histogram in a predetermined range in said second axis direction and an extreme value out of the range as an extreme value of said second histogram on the outside of said predetermined range in said second axis direction is smaller than a predetermined threshold, said determining unit determines the position in the direction of said second axis in which said second histogram has the extreme value out of the range, as a position in said first axis in the direction of said second axis.

8. The eye opening degree estimating apparatus according to claim 2, wherein
when the absolute value of a difference between an extreme value within a range as an extreme value of said second histogram in a predetermined range in said second axis direction and an extreme value out of the range as an extreme value of said second histogram on the outside of said predetermined range in said second axis direction is equal to or larger than a first threshold,
said determining unit compares said extreme value on the out of the range with an extreme value in the opposite direction as an extreme value in a concave direction opposite to that of said extreme value out of the range,
when the absolute value of the difference between said extreme value on the outside of the range and said extreme value in the opposite direction is smaller than a second threshold, sets the position in the direction of said second axis in which said second histogram has the extreme value in the range as a position in said first axis in the direction of said second axis, and
when the absolute value of the difference between said extreme value on the outside of the range and said extreme value in the opposite direction is equal to or larger than the second threshold, sets the position in the direction of said second axis in which said second histogram has an extreme value on the outside of the range as a position in said first axis in the direction of said second axis.

9. An eye opening degree estimating method for estimating the opening degree of an eye of a human, comprising:
an axis setting step of setting a first axis used for estimating the eye opening degree in an eye region image including an eye whose opening degree is to be estimated;
a first histogram generating step of generating a first histogram as a function expressing a distribution of integrated values in the direction of said first axis by integrating luminance values of said eye region image, in different positions in the direction of said first axis along the direction perpendicular to said first axis;
a feature amount deriving step of deriving a feature amount of at least one of said first histogram and said eye region image, in the position in the direction of said first axis in which said first histogram has an extreme value; and
an estimating step of estimating the opening degree of an eye included in said eye region image on the basis of said feature amount.

10. The eye opening degree estimating method according to claim 9, wherein
said axis setting step includes:
a second histogram generating step of generating a second histogram as a function expressing a distribution of integrated values in the direction of said second axis by integrating luminance values of said eye region image, in different positions in the direction of said second axis along the direction perpendicular to said second axis; and
a determining step of determining the position of said first axis in the direction of said second axis on the basis of a position in the direction of said second axis in which said second histogram has an extreme value.

11. The eye opening degree estimating method according to claim 9, wherein
in said first axis setting step, a principal axis of inertia almost perpendicular to open/close directions of an eyelid of an eye whose opening degree is to be estimated is detected, and said first axis is set in parallel with the principal axis of inertia.
